(19) United States
(12) Patent Application Publication
(10) Pub. No.: US 2025/0321419 A1
(43) Pub. Date: Oct. 16, 2025

(54) WAVEGUIDES WITH OPERATIONALLY COMPENSATING FEATURES

(71) Applicant: GOOGLE LLC, Mountain View, CA (US)

(72) Inventors: Joseph Daniel Lowney, Tucson, AZ (US); Kang Luo, San Jose, CA (US)

(21) Appl. No.: 18/631,379

(22) Filed: Apr. 10, 2024

(51) Int. Cl. G02B 27/00; G02B 27/01

(52) U.S. Cl. CPC G02B 27/0068; G02B 27/0172; G02B 2027/011

(57) ABSTRACT

Waveguides or associated structures with operationally compensating features are utilized in augmented reality (AR) or mixed reality (MR) display systems and include features such as a variable, thermally compensating thicknesses, pre-stressing, pre-compressing, or pre-tensioning. The operationally compensating features calibrate the compensating waveguides or structures such that performance of the waveguides is optimized for expected operating conditions or environments, such as expected thermal gradients, environmental factors such as ambient temperatures or weather, and/or mechanical stresses associated with operating a display that utilizes the waveguides or associated structures or user operation of such a display.

### BACKGROUND

In eyewear display devices, light from an image source is coupled into a lightguide substrate, generally referred to as a waveguide, by an optical input coupling element, such as an in-coupling grating (i.e., an “input coupler” or “incoupler”), which can be formed on a surface, or multiple surfaces, of the substrate or disposed within the substrate. Once the light beams have been coupled into the waveguide, the light beams are “guided” through the substrate, typically by multiple instances of total internal reflection (TIR) or by a coated surface(s). The guided light beams are then directed out of the waveguide by an output optical coupling (i.e., an “output coupler” or “outcoupler”), which can take the form of an optical grating (e.g., a diffractive, reflective, or refractive grating) or holographic structures. The output coupler directs the light at an eye relief distance from the waveguide, forming an exit pupil within which a virtual image generated by the image source can be viewed by a user of the display device. In many instances, an exit pupil expander, which can also take the form of an optical grating, is arranged in an intermediate stage between the input coupler and output coupler to receive light that is coupled into the waveguide by the input coupler, expand the light, and redirect the light towards the output coupler.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system that can utilize waveguides with operationally compensating features in accordance with some embodiments.

FIG. 2 is a diagram illustrating a cross-section view of an example implementation of a waveguide in accordance with some embodiments.

FIG. 3 shows an example of light propagation within a waveguide implementing a one-dimensional grating in accordance with some embodiments.

FIG. 4 shows an example of light propagation within a waveguide implementing a two-dimensional grating in accordance with some embodiments.

FIG. 5 shows example diagrams of thermal and thickness characteristics of a conventional waveguide exhibiting no thermal gradient and a conventional waveguide exhibiting a moderate thermal gradient.

FIG. 6 shows example diagrams of thermal and thickness characteristics of a conventional waveguide exhibiting a thermal gradient in example operating conditions and a conventional waveguide exhibiting an overheated thermal gradient.

FIG. 7 shows example diagrams of thermal and thickness characteristics of a thermally compensating waveguide exhibiting no thermal gradient and a thermally compensating waveguide exhibiting a moderate thermal gradient in accordance with some embodiments.

FIG. 8 shows example diagrams of thermal and thickness characteristics of a thermally compensating waveguide exhibiting a thermal gradient in expected operating conditions and a thermally compensating waveguide exhibiting an overheated thermal gradient in accordance with some embodiments.

FIG. 9 shows an example of a deformation compensating waveguide that has been pre-stressed to compensate for an expected deformation of the waveguide in accordance with some embodiments.

FIG. 10 shows an example of a deformation compensating structure associated with a waveguide that has been pre-stressed to compensate for an expected deformation of the structure in accordance with some embodiments.

FIG. 11 shows an example method of identifying or modifying a design for a waveguide or a structure associated with the waveguide based on an indication of an expected thermal gradient, environmental condition, or deformation in accordance with some embodiments.

### DETAILED DESCRIPTION

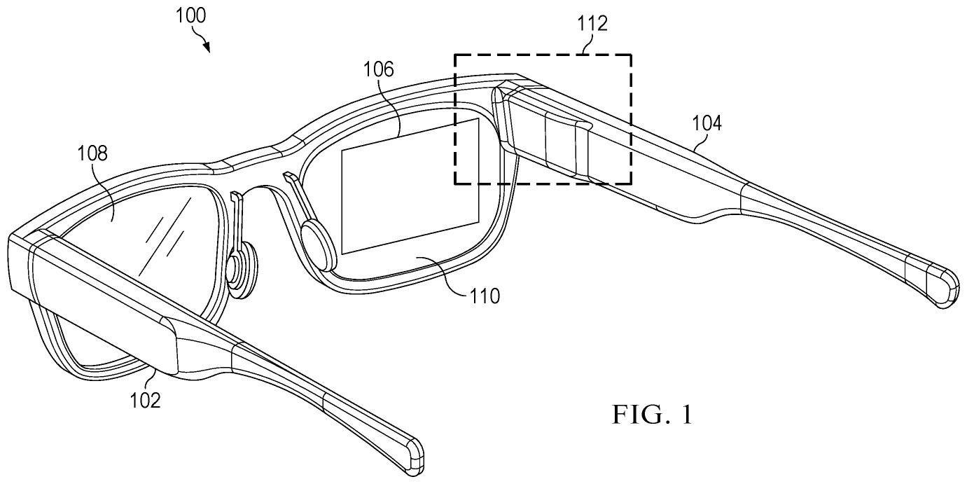

FIGS. 1-11 illustrate various techniques for implementing waveguides with features that compensate for expected deformations of an optical substrate or carrying frame for the optical substrate due to thermal or mechanical stress variations during use. Aspects of the present disclosure are directed to using waveguides with operationally compensating features to overcome non-ideal or degraded performance characteristics of conventional waveguides in operating conditions or environments. For example, conventional waveguides often exhibit thermal and thickness variations when a display system utilizing the waveguides causes the waveguide to become heated due to, e.g., heat from a light engine or a light source. Other factors such as environmental conditions, assembly, and user operation of the display system also can impart thickness variations onto conventional waveguides. Such thickness variations often lead to suboptimal performance of the waveguide due to deformations that can result in the waveguide deviating from a flat profile and/or optical structures in the waveguide being warped or otherwise deformed. For example, under normal operating conditions, heat generated by a micro-display or other electronics produces a thermal load that causes thermal expansion of a waveguide. As different areas of the waveguide expand, the thickness profile of the waveguide deviates from, e.g., a nominally flat profile that would provide a clear image for a user. Similarly, an eyewear display device carried by a frame undergoes mechanical stress when the device is donned by a user, which can manifest as deformation such as thickness variation or bending.

In order to overcome the degraded performance characteristics of conventional waveguides in operating conditions or environments, in some embodiments, a waveguide design includes operationally compensating features such as a variable, thermally compensating thickness. In some embodiments, waveguides or associated structures are pre-stressed, pre-compressed, or pre-tensioned. Generally, the operationally compensating features disclosed herein tune or calibrate the compensating waveguides such that performance of the waveguides is optimized for expected operating conditions or environments, such as expected thermal gradients, environmental factors such as ambient temperatures or weather, and/or mechanical stresses that would degrade the performance of conventional waveguides.

FIG. 1 illustrates an example display system 100 capable of utilizing waveguides with operationally compensating features in accordance with some embodiments. It should be understood that the waveguide configurations of one or more embodiments are not limited to display system 100 of FIG. 1 and apply to other display systems. In at least some embodiments, the display system 100 comprises a support structure 102 that includes an arm 104, which houses a light engine configured to project images toward the eye of a user such that the user perceives the projected images as being displayed in a field of view (FOV) area 106 of a display at one or both of lens elements 108, 110. In the depicted embodiment, the display system 100 is a near-eye display system in the form of an eyewear display device that includes the support structure 102 configured to be worn on the head of a user and has a general shape and appearance of an eyeglasses frame. The support structure 102 includes various components to facilitate the projection of such images toward the eye of the user, such as light engines (i.e., micro-displays), optical scanners, and/or waveguides. In at least some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a Wireless Fidelity (WiFi) interface, and the like.

Further, in at least some embodiments, the support structure 102 includes one or more batteries or other portable power sources for supplying power to the electrical components of the display system 100. In at least some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments, the display system 100 may have a different shape and appearance from the eyeglasses frame depicted in FIG. 1.

In some embodiments, both of the lens elements 108, 110 are used by the display system 100 to provide an augmented reality (AR) or mixed reality (MR) display in which rendered graphical content is superimposed over or otherwise provided in conjunction with a real-world view as perceived by the user through the lens elements 108, 110. For example, display light used to form a perceptible image or series of images may be projected by a light engine of the display system 100 onto the eye of the user via a series of optical elements, such as a waveguide formed at least partially in the corresponding lens element, one or more scan mirrors, and/or one or more optical relays. Thus, the lens elements 108, 110 each include at least a portion of a waveguide that routes display light received by an input coupler, or multiple input couplers, of the waveguide to an output coupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In at least some embodiments, the light engine is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The light engine, in at least some embodiments, includes multiple micro-LEDs. The light engine is communicatively coupled to a controller and a non-transitory processor-readable storage medium or memory storing processor-executable instructions and other data that, when executed by the controller, cause the controller to control the operation of the light engine. In at least some embodiments, the controller controls a scan area size and scan area location for the light engine and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

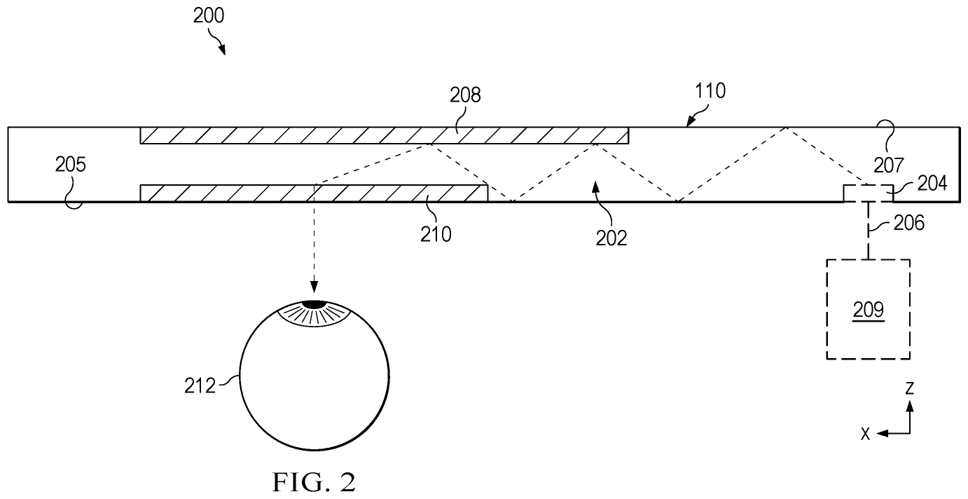

FIG. 2 depicts a cross-section view 200 of an implementation of a lens element 110 of a display system such as the display system 100 of FIG. 1. Note that for purposes of illustration, at least some dimensions in the Z direction are exaggerated for improved visibility of the represented aspects. In this example implementation, a waveguide 202, which may form a portion of the lens element 110 of FIG. 1, implements optical structures in a region 208 on the opposite side of the waveguide 202 of a region 210 as reflective, refractive, diffractive, or holographic optical structures. In some embodiments, the reflective, refractive, diffractive, or holographic optical structures of an incoupler 204 are implemented on an eye-facing side 205 of the lens element 110. Likewise, the optical structures of region 210 (which provide outcoupler functionality) are implemented at the eye-facing side 205. Further in the illustrated implementation, the optical structures of region 208 (which provide EPE functionality) are implemented at a world-facing side 207 of the lens element 110 that is opposite the eye-facing side 205. Thus, under this approach, display light 206 from a light source 209 is incoupled to the waveguide 202 via the incoupler 204, and propagated (through total internal reflection in this example) toward the region 208, whereupon the optical structures of the region 208 diffract the incident display light for exit pupil expansion purposes, and the resulting light is propagated to the optical structures of the region 210, which output the display light toward a user's eye 212. In other implementations, the positions of regions 208 and 210 may be reversed, with the optical structures of region 210 formed on the world-facing side 207 and the optical structures of region 208 formed on the eye-facing side 205, however, this may result in the regions 208 and 210 having different positions, dimensions, and shapes, and also may require optical structures in each region to have different characteristics.

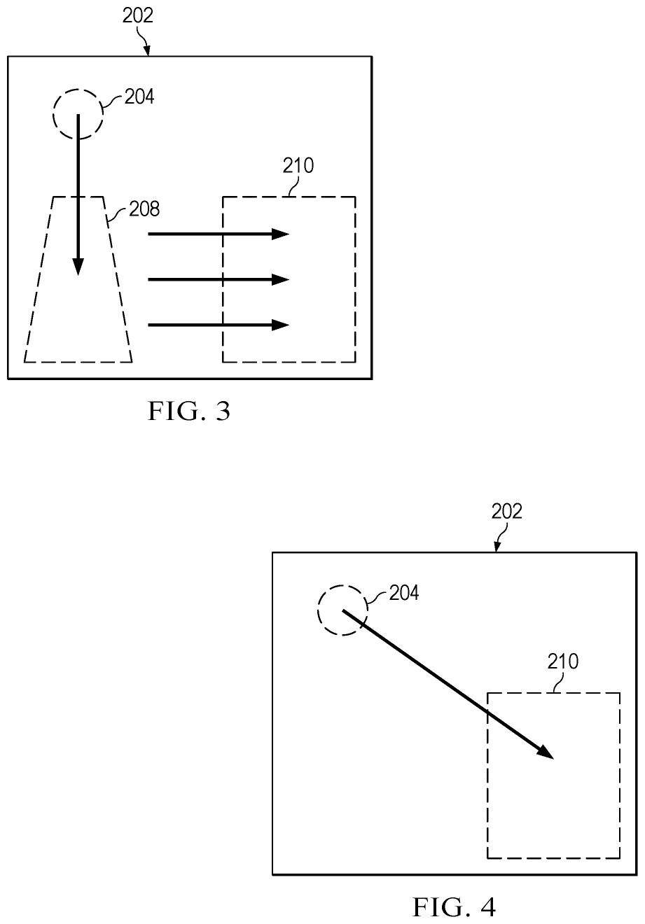

FIG. 3 shows an example of light propagation within the waveguide 202 of FIG. 2 when one-dimensional (1D) optical gratings or structures are implemented in accordance with some embodiments. As shown, light received via the incoupler 204 is directed into the region 208 and then routed to the region 210 to be output (e.g., toward the eye 212 of the user). In some embodiments, region 208 expands one or more dimensions of the eyebox of a display system (e.g., the display system 100 of FIG. 1) that includes the light source 209 (e.g., with respect to what the dimensions of the eyebox of the display would be without the region 208). In some embodiments, the incoupler 204 and the region 208 each include respective 1D optical structures (e.g., refractive, diffractive, or reflective gratings or holographic structures that extend along one dimension), which redirect incident light in a particular direction depending on the angle of incidence of the incident light and the structural aspects of the optical gratings. It should be understood that FIG. 3 shows a substantially ideal case in which the incoupler 204 directs light straight down (with respect to the presently illustrated view), and the region 208 directs light to the right (with respect to the presently illustrated view) in a second direction that is perpendicular to the first direction. While not shown in the present example, it should be understood that, in some embodiments, the first direction in which the incoupler 204 directs light is slightly or substantially diagonal.

In at least some embodiments, the region 208 and the region 210 are separated into or onto separate sections of the waveguide 202. For example, the incoupler 204 and the region 208 are located in or on a first section, and the region 210 is located in or on a second section, where a planar direction of the first section is substantially parallel to a planar direction of the second section. In some embodiments, the incoupler 204 and the region 208 are located in or on a first substrate, and the region 210 is located in or on a second substrate, where the first substrate and the second substrate are arranged adjacent to one another.

The waveguide 202, in at least some embodiments, includes multiple substrates with the region 208 located in or on a first substrate and the region 210 located in or on a second substrate that is separate from and adjacent to the first substrate. In some embodiments, a partition element is placed between the first substrate and the second substrate. For example, the partition element is an airgap (or gas-filled gap), a low-index refractive material layer, a polarizing beam splitter layer, or any combination thereof. In at least some embodiments, the partition element includes additional elements or an opening to direct light from the first substrate to the second substrate.

FIG. 4 shows another example of light propagation within the waveguide 202 of FIG. 2 when two-dimensional gratings (2D) are implemented in accordance with some embodiments. As shown, light received via the incoupler 204 is routed to the region 210 to be output (e.g., toward the eye 212 of the user). In the example shown in FIG. 4, the region 208 is not implemented by the waveguide 202 or is combined with the region 210. If the region 208 is combined with the region 210, the region 210 may expand one or more dimensions of the eyebox of the display system as described above. In this example, the region 210 includes a 2D diffraction grating(s) (i.e., a diffraction grating(s) that extends along two dimensions), which diffracts incident light in a particular direction depending on the angle of incidence of the incident light and the structural aspects of the optical gratings or structures.

However, the functionality of waveguides such as the waveguide 202 of FIG. 2 when utilized in devices such as the display system 100 of FIG. 1 can deviate from functionality the waveguides would have in ideal operating conditions, e.g., room temperature (i.e., approximately 72 degrees Fahrenheit), when exposed to actual operating conditions, such as thermal gradients across the waveguide or mechanical deformations. For example, in some situations, in addition to the waveguide itself, the optical structures in, e.g., the incoupler 204 and the region 210 of the waveguide 202 of FIGS. 2 and 4, as well as the optical structures in, e.g., the region 208 of the waveguide 202 of FIGS. 2 and 3 become warped or otherwise deformed when exposed to actual operating conditions. In conventional waveguides, these deformations often result in the waveguide and/or optical structures being modified from their ideal design configurations (e.g., flat within 1 micron thickness variation across the waveguide), which can result in the eyebox of the display being reduced or dislocated, color fringing effects causing visible separation of colors and creating a fringed or colored halo effect, blurring of a displayed image, and so on.

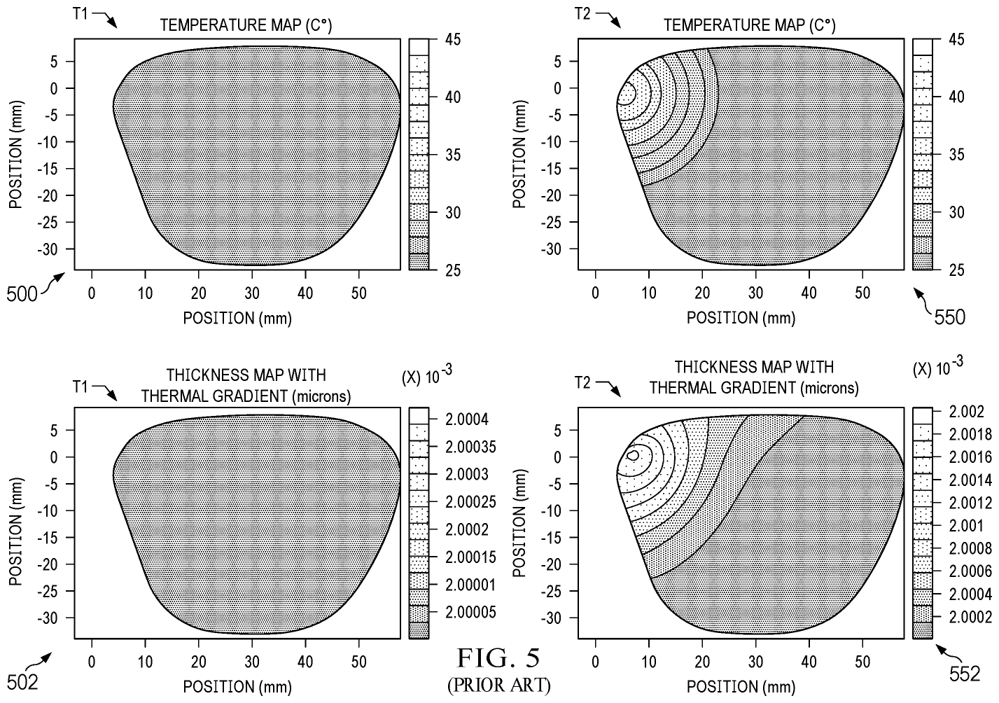

For example, the left-hand portion of FIG. 5 shows an example diagram 500 of thermal characteristics and an example diagram 502 of thickness characteristics of a conventional waveguide exhibiting no thermal gradient at a time “T1,” such as when a display system utilizing the waveguide is not activated, operational, or powered on, resulting in the waveguide exhibiting what is often referred to as a “cold” state, which may correspond to room temperature conditions. As can be seen in the thermal diagram 500 and the thickness diagram 502, a conventional waveguide may exhibit a static or constant temperature profile and little or no thickness variation at room temperature. Conventional waveguides are often designed to operate ideally at room temperatures, and so the thermal diagram 500 and the thickness diagram 502 represent optimal operating conditions for many conventional waveguides. However, in operation, a waveguide often exhibits a thermal gradient resulting from operation of a display utilizing the waveguide or environmental conditions, for example, which can result in the waveguide exhibiting non-ideal or degraded performance characteristics.

For example, the right-hand portion of FIG. 5 shows an example diagram 550 of thermal characteristics and an example diagram 552 of thickness characteristics of a conventional waveguide exhibiting a moderate thermal gradient at a time “T2,” such as when a display system utilizing the waveguide has been activated or powered on such that it is operational. As can be seen in the thermal diagram 550 and the thickness diagram 552, a conventional waveguide often begins to exhibit temperature changes proximate to the location of display components of a display system utilizing the waveguide, such as the location of one or more light engines, light sources, or incouplers associated with the waveguide. The heat imparted into the waveguide often results in a moderate thermal gradient, as shown in the thermal diagram 550, which in turn, due to thermal expansion, results in the waveguide exhibiting a minor deformation gradient or thickness variation radiating outward from an origin or central location of the heat source (e.g., a light source directing light into an incoupler of the waveguide), as shown in the thickness diagram 552. As noted above, the resulting thermal gradient can result in the waveguide exhibiting non-ideal or degraded performance characteristics compared to the performance of the waveguide at room temperature (e.g., as represented by the thermal diagram 500 and the thickness diagram 502).

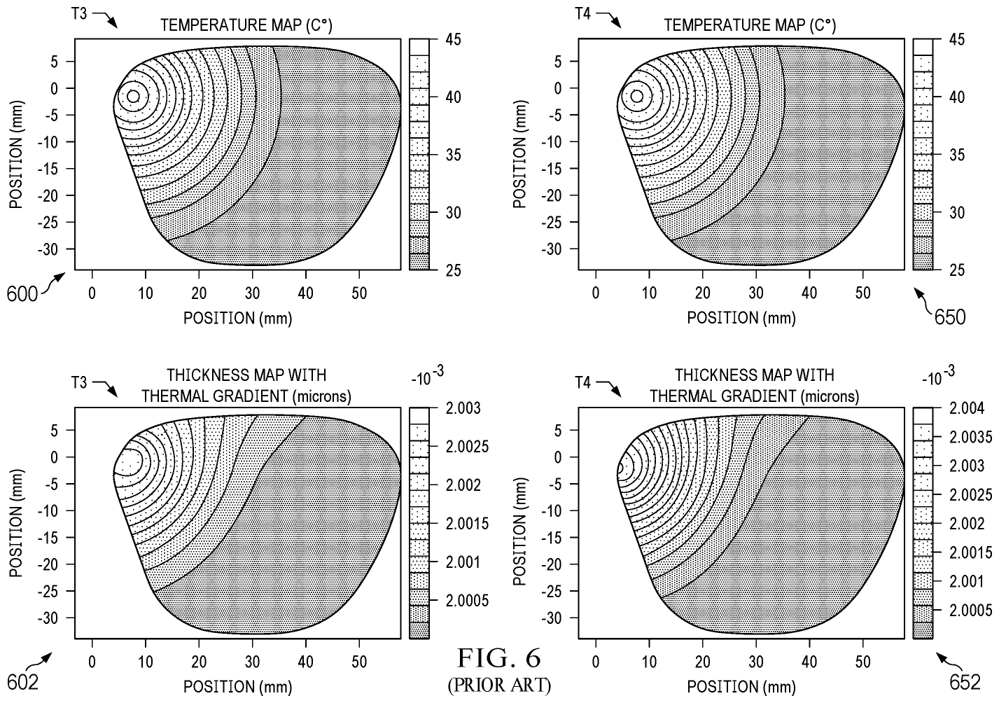

The left-hand portion of FIG. 6 shows an example diagram 600 of thermal characteristics and an example diagram 602 of thickness characteristics of a conventional waveguide exhibiting a thermal gradient in example operating conditions at a time “T3,” such as when a display system utilizing the waveguide has been activated or powered on and the display has been operational for a period of time beyond that represented in the thermal diagram 550 and the thickness diagram 552 of FIG. 5. As can be seen in the thermal diagram 600 and the thickness diagram 602, the heat imparted into the waveguide by components of the display system often results in an increased thermal gradient compared to that shown in the thermal diagram 550 of FIG. 5, which in turn, due to thermal expansion, results in the waveguide exhibiting a more significant, increased thickness variation radiating outward from an origin or central location of the heat source, as shown in the thickness diagram 602, compared to the thickness variation shown in thickness diagram 552 of FIG. 5. The resulting increased thermal gradient can result in the waveguide exhibiting further exacerbated non-ideal or degraded performance characteristics compared to the performance of the waveguide represented by the thermal diagram 550 and the thickness diagram 552 of FIG. 5.

The right-hand portion of FIG. 6 shows an example diagram 650 of thermal characteristics and an example diagram 652 of thickness characteristics of a conventional waveguide exhibiting an overheated thermal gradient at a time “T4,” such as when a display system utilizing the waveguide has been activated or powered on and the display has been operational for a period of time beyond that represented in the thermal diagram 600 and the thickness diagram 602. As can be seen in the thermal diagram 650 and the thickness diagram 652, the heat imparted into the waveguide by components of the display system often results in a further increased thermal gradient compared to that shown in the thermal diagram 600, which in turn, due to thermal expansion, results in the waveguide exhibiting an even more significant, further increased thickness variation radiating outward from an origin or central location of the heat source, as shown in the thickness diagram 652, compared to the thickness variation shown in thickness diagram 602. The resulting increased thermal gradient can result in the waveguide exhibiting even further, more exacerbated non-ideal or degraded performance characteristics compared to the performance of the waveguide represented by the thermal diagram 600 and the thickness diagram 602.

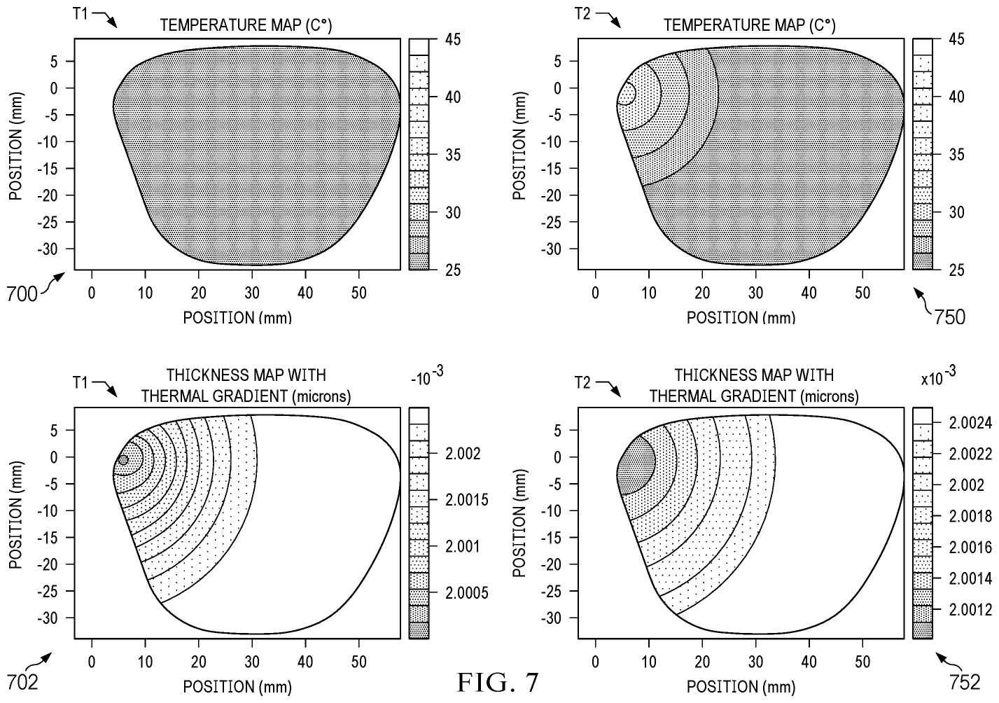

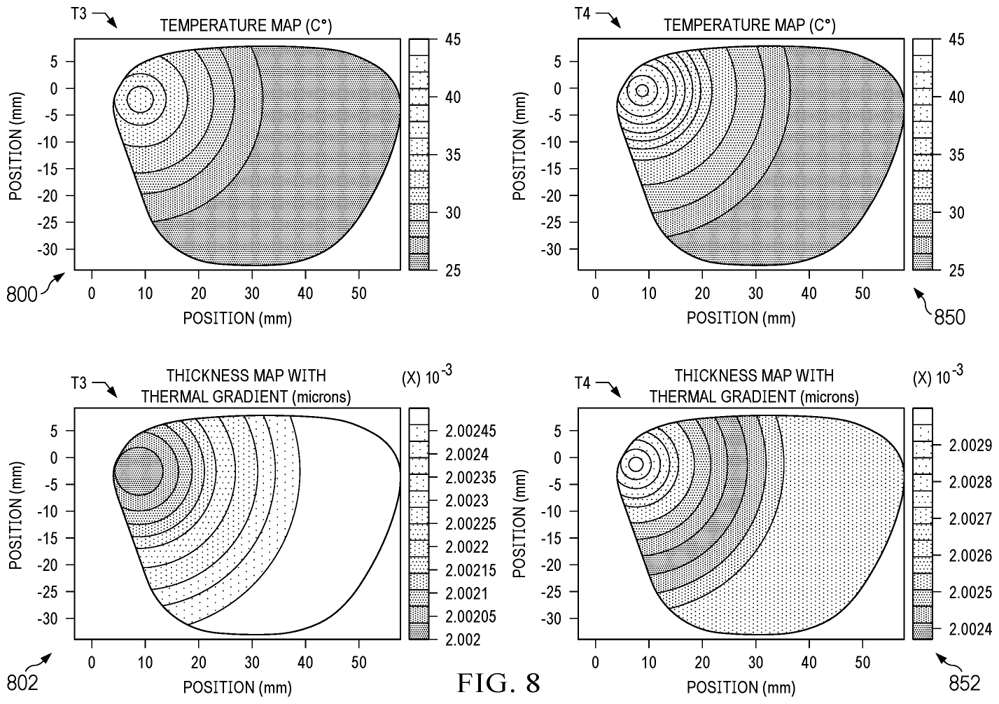

By using waveguides with operationally compensating features in accordance with aspects of the present disclosure, in some embodiments, the above-noted non-ideal or degraded performance characteristics of conventional waveguides exhibiting thermal and thickness variations like those shown in FIGS. 5 and 6 are mitigated or overcome. For example, as shown in FIGS. 7 and 8, in some embodiments, the above-noted non-ideal or degraded performance characteristics of conventional waveguides are significantly overcome by varying a thickness of a waveguide to compensate for expected thermal changes during operation, e.g., an increasing thickness as a function of a distance from an expected “hot spot” of the waveguide, such as the location of a light source or an incoupler associated with the waveguide so that a waveguide having a variable thickness when not in use becomes flat or nearly flat when in use and experiencing a thermal load from, e.g., a light engine or other electronics.

The left-hand portion of FIG. 7 shows an example diagram 700 of thermal characteristics and an example diagram 702 of thickness characteristics of a thermally compensating waveguide, such as the waveguide 202 of FIG. 2 as utilized in the display system 100 of FIG. 1, exhibiting no thermal gradient in accordance with some embodiments at a time “T1,” such as when a display system utilizing the waveguide is not activated, operational, or powered on, resulting in the waveguide exhibiting a “cold” state, which may correspond to room temperature conditions. Although the thermally compensating waveguide exhibits a static or constant temperature profile, as can be seen in the thermal diagram 700, the thermally compensating waveguide includes substantial thickness variation at room temperature, as seen in the thickness diagram 702. In some embodiments, as noted above, the thermally compensating waveguide includes a variable, thermally compensating thickness, e.g., an increasing thickness at room temperature as a function of a distance from an expected “hot spot” of the waveguide, such as the location of a light source or an incoupler associated with the waveguide, as shown for example in the thickness diagram 702, in order to compensate for an expected thickness variation, which may be similar to the thickness variation illustrated in the diagram 602 of thickness characteristics in FIG. 6 representing example operating conditions at a time T3. In some embodiments, as illustrated in the thickness diagram 702 of FIG. 7, the variable, thermally compensating thickness includes a smaller thickness proximate to the “hot spot,” such as an incoupler associated with the waveguide, compared to other thicknesses of the variable, thermally compensating thickness. By varying the thickness of the waveguide to compensate for thermal variations that are expected to occur when in use, e.g., as a function of an expected deformation gradient or thickness variation resulting from thermal expansion of the waveguide during operation of a display system utilizing the waveguide, the thermally compensating waveguide is tuned or calibrated to compensate for the expected operational deformations.

For example, the right-hand portion of FIG. 7 shows an example diagram 750 of thermal characteristics and an example diagram 752 of thickness characteristics of a thermally compensating waveguide exhibiting a moderate thermal gradient in accordance with some embodiments at a time “T2,” such as when a display system utilizing the waveguide has been activated or powered on such that it is operational. As shown in the thermal diagram 750, the thermal gradient exhibited by the waveguide has increased slightly compared to the thermal diagram 700; however, the thickness variation in the waveguide is less pronounced due to thermal expansion, as shown in the thickness diagram 752, compared to the thickness variation shown in the thickness diagram 702.

The left-hand portion of FIG. 8 shows an example diagram 800 of thermal characteristics and an example diagram 802 of thickness characteristics of a thermally compensating waveguide, such as the waveguide 202 of FIG. 2 as utilized in the display system 100 of FIG. 1, exhibiting a thermal gradient in expected operating conditions in accordance with some embodiments at a time “T3,” such as when a display system utilizing the waveguide has been activated or powered on and the display has been operational for a period of time beyond that represented in the thermal diagram 750 and the thickness diagram 752 of FIG. 7. As shown in the thermal diagram 800, the thermal gradient exhibited by the waveguide has increased compared to the thermal diagram 750; however, the thickness variation in the waveguide has become even less pronounced due to thermal expansion, as shown in the thickness diagram 802, compared to the thickness variation shown in the thickness diagram 752. Accordingly, by designing or modifying thermally compensating waveguides to have a variable, thermally compensating thickness, thickness variations in the waveguide are minimized when the waveguides exhibit thermal gradients corresponding to expected operating conditions, thus improving the performance of the thermally compensating waveguides compared to conventional waveguides, as the thermally compensating waveguides are flatter than conventional waveguides and components of the thermally compensating waveguides are not as deformed as those in conventional waveguides under operating conditions.

Accordingly, although in some embodiments a thermally compensating waveguide could be considered to exhibit degraded performance until a display system, such as an AR display, is activated, as a consequence of the thickness variation shown in, e.g., the thickness diagram 702 of FIG. 7, this degraded performance is typically of little consequence as the waveguide is typically transparent or substantially transparent when the corresponding display system is not in operation. However, as a consequence of the reduced thickness variation shown in, e.g., the thickness diagram 802 of FIG. 8 under expected operating conditions, performance of the thermally compensating waveguide is improved when the waveguide exhibits an expected operational thermal gradient, such as that shown in the thermal diagram 800 of FIG. 8, compared to the performance of the waveguide when the waveguide exhibits a lower thermal gradient, such as the thermal gradients shown in the thermal diagram 700 and the thermal diagram 750 of FIG. 7, or a higher thermal gradient, such as the thermal gradient shown in the thermal diagram 850 of FIG. 8, as a consequence of the thickness variations corresponding to those thermal gradients. In some embodiments, this improved performance of the thermally compensating waveguide results from the variable, thermally compensating thickness of the waveguide, e.g., at room temperature, as shown in the thickness diagram 702 of FIG. 7, compensating for the waveguide exhibiting a thermal gradient resulting from operation of a corresponding display system, such as an AR display. For example, as shown in the thickness diagram 702 of FIG. 7, in some embodiments, the waveguide is thinner at a region proximal to the location of, e.g., a micro-display associated with an incoupler of the waveguide and thicker at a region distal from the micro-display when the eyewear display device is not in use. In some embodiments, the waveguide has a lower total thickness variation when the eyewear display device is in use, as shown in the thickness diagram 802 of FIG. 8, than when the eyewear display device is not in use, as shown in the thickness diagram 702 of FIG. 7. In some embodiments, the thickness of the waveguide when not in use increases as a function of a distance from the micro-display or the incoupler of the waveguide.

The right-hand portion of FIG. 8 shows an example diagram 850 of thermal characteristics and an example diagram 852 of thickness characteristics of a thermally compensating waveguide exhibiting an overheated thermal gradient in accordance with some embodiments at a time “T4,” such as when a display system utilizing the waveguide has been activated or powered on and the display has been operational for a period of time beyond that represented in the thermal diagram 800 and the thickness diagram 802. As shown in the thermal diagram 850, at time T4, the thermal gradient exhibited by the waveguide has further increased compared to the thermal diagram 800 at time T3. However, although the thickness variation in the thermally compensating waveguide has become more pronounced due to thermal expansion, as shown in the thickness diagram 852, compared to the thickness variation shown in the thickness diagram 802, it will be appreciated that the thickness variation of the thermally compensating waveguide as shown in the thickness diagram 852 is significantly less pronounced than the thickness variation of the conventional waveguide shown in the thickness diagram 652 in an overheated state at a similar time T4. Accordingly, even in overheated conditions, the thermally compensating waveguide provides improved performance compared to a conventional waveguide.

Although FIGS. 7 and 8 and the discussion above provide an example of providing the operationally compensating feature of a variable, thermally compensating thickness that compensates for heat generated by, e.g., a light engine or light source of a display system in a thermally compensating waveguide, in some embodiments, in addition to or alternatively to compensating for heat generated by a display system utilizing the waveguide, a thermally compensating waveguide is designed or modified to have a thermally compensating thickness in order to account for expected environmental conditions. For example, in some environments, such as tropical or arctic environments, a high temperature factory environment, or a refrigerated working environment, thermal gradients resulting from operating a corresponding display system may be less or more pronounced than thermal gradients resulting from operating the display system in a room temperature environment. Additionally, sunlight or other weather conditions such as rain or snow may cause their own associated thermal gradients in a waveguide, sometimes additionally depending on the color of the eyeglasses frame or other support structure in which the waveguide is contained and/or a tint of a lens associated with the waveguide. Accordingly, in some embodiments, the variable, thermally compensating thickness in a thermally compensating waveguide includes thickness variations that compensate for expected environmental conditions, expected colors of support structures, and/or expected tinting of associated lenses.

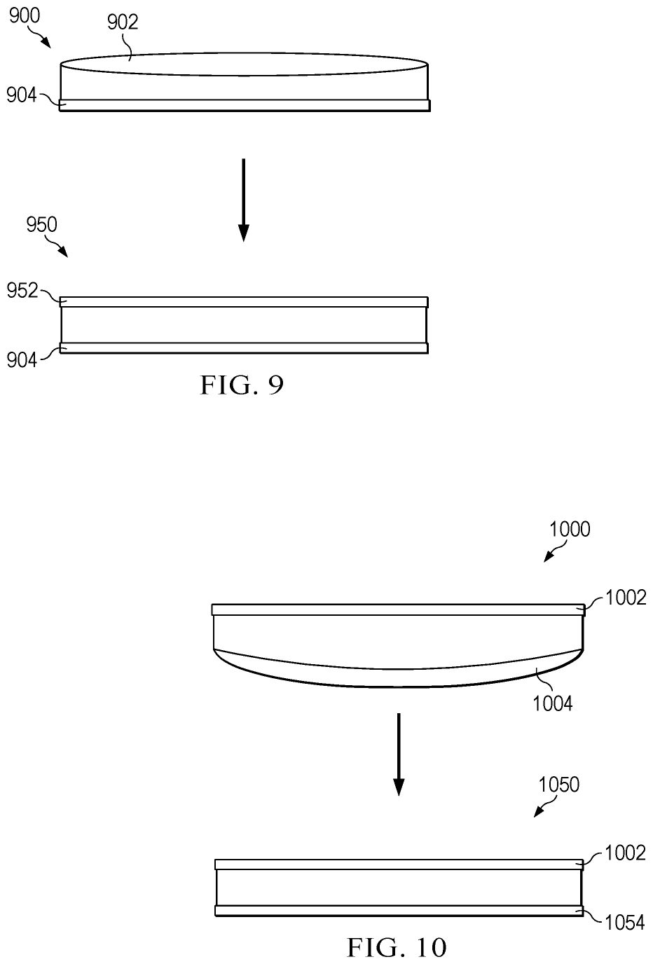

In addition to heat generated by, e.g., a light engine or light source of a display system causing changes in thicknesses of a waveguide, changes in temperature due to environmental factors such as temperature shifts or user manipulation of a display system utilizing such a waveguide, such as donning a device utilizing such a system, can result in more general warping or deformation of a waveguide or structure associated with the waveguide, such as a frame. This warping or deformation can also cause degradation in the performance of the waveguide, and so, in some embodiments, waveguides or structures associated with waveguides include features to compensate for these more general warping or deformation effects. FIG. 9 shows an example of a deformation compensating waveguide that has been pre-stressed to compensate for an expected deformation of the waveguide in accordance with some embodiments. As shown in diagram 900, a deformation compensating waveguide 902 is pre-stressed, pre-compressed, or pre-tensioned such that, e.g., at room temperature, a structure associated with the waveguide 902, such as a frame 904 to which the waveguide 902 is mounted, retains the waveguide 902 in a deformed shape. However, as shown in diagram 950, when exposed to expected operational conditions, such as heat from a display system utilizing the waveguide 902 or environmental conditions, the waveguide 952 and/or frame 904 expands or contracts, which relieves the stress on the waveguide 902 and results in the waveguide 952 taking on a flatter shape or profile, thus ensuring approximately optimal performance of the waveguide 952. Thus, in some embodiments, a deformation compensating waveguide is pre-stressed, pre-compressed, or pre-tensioned to compensate for the waveguide or a structure associated with the waveguide exhibiting or responding to a thermal gradient resulting from operation of a display system, such as an AR display, or from environmental conditions.

FIG. 10 shows an example of a deformation compensating structure associated with a waveguide that has been pre-stressed to compensate for an expected deformation of the structure in accordance with some embodiments. As shown in diagram 1000, a deformation compensating frame 1004 is pre-stressed, pre-compressed, or pre-tensioned such that, e.g., at room temperature, the frame 1004 to which a waveguide 1002 is mounted retains the waveguide 1002 in a deformed shape. However, as shown in diagram 1050, when exposed to expected operational conditions, such as heat from a display system utilizing the waveguide 1002 or environmental conditions, the frame 1054 expands or contracts, which prevents stresses from being applied to the waveguide 1002 and results in the waveguide 1002 maintaining a flatter shape or profile, thus ensuring approximately optimal performance of the waveguide 902. Thus, in some embodiments, a deformation compensating structure associated with a waveguide, such as a frame for the waveguide, is pre-stressed, pre-compressed, or pre-tensioned to compensate for the structure exhibiting or responding to an expected thermal gradient resulting from operation of a display system, such as an AR display, or from expected environmental conditions during operation of a display system utilizing the waveguide.

In accordance with the examples of FIGS. 9 and 10, in some embodiments, when a waveguide or a structure associated with the waveguide is pre-stressed, pre-compressed, or pre-tensioned to compensate for an expected deformation of the waveguide or the structure, performance of the waveguide is improved in operation compared to performance of the waveguide when not in use, as the waveguide may exhibit undesirable deformations until the pre-stressing, pre-compression, or pre-tensioning is relieved in the presence of an expected thermal gradient resulting from operation of a display system utilizing the waveguide or environmental conditions. As a result, the waveguide could be considered to exhibit degraded performance until a display system utilizing the waveguide, such as an AR display, is activated. However, this degraded performance is typically of little consequence as the waveguide is typically transparent or substantially transparent when the corresponding display system is not in operation.

Although FIGS. 9 and 10 are directed to pre-stressing, pre-compressing, or pre-tensioning a waveguide or a structure associated with the waveguide to compensate for an expected deformation of the waveguide or the structure in the presence of an expected thermal gradient and/or expected environmental conditions, in some embodiments, a deformation compensating waveguide and/or structure is pre-stressed, pre-compressed, or pre-tensioned to compensate for stresses the waveguide and/or structure experience during assembly of a display device utilizing the waveguide and the structure. In some embodiments, a deformation compensating waveguide and/or structure is pre-stressed, pre-compressed, or pre-tensioned to compensate for stresses the waveguide and/or structure experience during use of the display device, such as deformations that are expected to result from a user putting on or wearing the device (e.g., stresses on the frame that may result from a user's head spreading the arms of an eyeglasses frame). In some embodiments, pre-stressing, pre-compressing, or pre-tensioning a waveguide or a structure associated with the waveguide as described with reference to, e.g., FIGS. 9 and 10 includes utilizing a casting process, an injection molding process, a subtractive polishing process, a chemical mechanical polishing process, an etching process such as with a reactive ion beam, an additive process, an inkjet dispensing process, selectively coating with selective physical vapor deposition, and/or selectively coating with selective atomic layer deposition. For example, in some embodiments, an existing, conventional waveguide is modified to have operationally compensating features by adding material to or removing material from the waveguide using one of the processes mentioned above to, e.g., provide a variable, thermally compensating thickness.

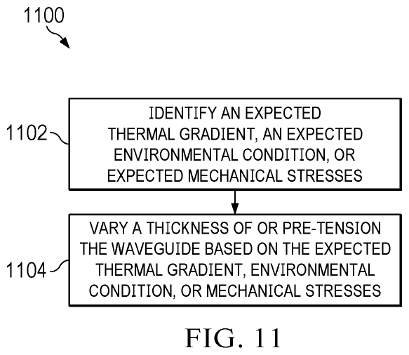

FIG. 11 shows an example method 1100 of varying a profile of a waveguide based on an expected deformation of the waveguide profile due to a thermal gradient, environmental condition, mechanical stress, or other deformation in accordance with some embodiments. At block 1102, the method 1100 includes identifying an expected thermal gradient, an expected environmental condition, or mechanical stresses resulting from an expected deformation of the waveguide. At block 1104, the method 1100 includes varying a thickness of or pre-tensioning the waveguide based on the expected thermal gradient, environmental conditions, or mechanical stresses. For example, as described above with reference to FIGS. 7-9, in some embodiments, the method 1100 includes adding operationally compensating features to a waveguide design or modifying an existing waveguide to include such operationally compensating features, which may include, e.g., a variable, thermally compensating thickness and/or pre-stressing, pre-compressing, or pre-tensioning the waveguide or a structure associated with the waveguide to compensate for an expected thermal gradient, environmental condition, and/or deformation. In some embodiments, varying the thickness of or pre-tensioning the waveguide includes utilizing a casting process, an injection molding process, a subtractive polishing process, a chemical mechanical polishing process, an etching process such as with a reactive ion beam, an additive process, an inkjet dispensing process, selectively coating with selective physical vapor deposition, and/or selectively coating with selective atomic layer deposition.

In some embodiments, varying the thickness of the waveguide includes providing the waveguide with a variable thickness to compensate for expected changes in thickness when the eyewear display device is in use. In some embodiments, varying the thickness of the waveguide includes providing the waveguide with a smaller thickness at a region proximal to a micro-display of the eyewear display device and a larger thickness at a region distal from the micro-display when the eyewear display device is not in use. In some embodiments, varying the thickness of the waveguide includes providing the waveguide with a smaller thickness at a region proximal to an incoupler of the waveguide and a larger thickness at a region distal from the incoupler when the eyewear display device is not in use. In some embodiments, varying the thickness of the waveguide includes providing the waveguide with a thickness that increases as a function of a distance from a micro-display of the eyewear display device.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear display device, comprising:
a micro-display to generate display light; and
a waveguide to guide the display light to an exit pupil, wherein the waveguide is thinner at a region proximal to the micro-display and thicker at a region distal from the micro-display when the eyewear display device is not in use.

2. The eyewear display device of claim 1, wherein the waveguide has a variable thickness to compensate for expected changes in thickness when the eyewear display device is in use.

3. The eyewear display device of claim 2, wherein the variable thickness compensates for the waveguide exhibiting a thermal gradient resulting from operation of the eyewear display.

4. The eyewear display device of claim 3, wherein the waveguide or a structure associated with the waveguide is pre-stressed, pre-compressed, or pre-tensioned to compensate for the waveguide exhibiting the thermal gradient.

5. The eyewear display device of claim 1, wherein the waveguide has a lower total thickness variation when the eyewear display device is in use than when the eyewear display device is not in use.

6. The eyewear display device of claim 1, wherein the waveguide is thinner at a region proximal to an incoupler associated with the waveguide and thicker at a region distal from the incoupler when the eyewear display device is not in use.

7. The eyewear display device of claim 1, wherein a thickness of the waveguide increases as a function of a distance from the micro-display.

8. An eyewear display device, comprising:
a micro-display to generate display light; and
a waveguide to guide the display light to an exit pupil, wherein the waveguide or a structure associated with the waveguide is pre-stressed, pre-compressed, or pre-tensioned to compensate for an expected deformation of the waveguide or the structure.

9. The eyewear display device of claim 8, wherein the waveguide is thinner at a region proximal to the micro-display and thicker at a region distal from the micro-display when the eyewear display device is not in use.

10. The eyewear display device of claim 8, wherein the waveguide has a lower total thickness variation when the eyewear display device is in use than when the eyewear display device is not in use.

11. The eyewear display device of claim 8, wherein the waveguide is pre-stressed, pre-compressed, or pre-tensioned based on expected environmental conditions, assembly of the device, or use of the eyewear display device.

12. The eyewear display device of claim 8, wherein the waveguide has a variable thickness when the eyewear display device is not in use to compensate for expected changes in thickness when the eyewear display device is in use.

13. The eyewear display device of claim 8, wherein the waveguide is thinner at a region proximal to an incoupler associated with the waveguide and thicker at a region distal from the incoupler when the eyewear display device is not in use.

14. A method, comprising:
varying a thickness of a waveguide for an eyewear display device based on an expected thermal gradient, expected environmental conditions, or expected mechanical stresses when the eyewear display device is in use.

15. The method of claim 14, wherein varying the thickness of the waveguide includes providing the waveguide with a variable thickness when the eyewear display device is not in use to compensate for expected changes in thickness when the eyewear display device is in use.

16. The method of claim 14, wherein varying the thickness of the waveguide includes providing the waveguide with a smaller thickness at a region proximal to a micro-display of the eyewear display device and a larger thickness at a region distal from the micro-display when the eyewear display device is not in use.

17. The method of claim 14, wherein varying the thickness of the waveguide includes providing the waveguide with a smaller thickness at a region proximal to an incoupler of the waveguide and a larger thickness at a region distal from the incoupler when the eyewear display device is not in use.

18. The method of claim 14, wherein varying the thickness of the waveguide includes providing the waveguide with a thickness that increases as a function of a distance from a micro-display of the eyewear display device.

19. The method of claim 14, wherein varying the thickness of the waveguide is performed using a casting process, an injection molding process, a subtractive polishing process, a chemical mechanical polishing process, an etching process, an additive process, an inkjet dispensing process, selectively coating with selective physical vapor deposition, or selectively coating with selective atomic layer deposition.

20. The method of claim 14, further comprising pre-tensioning the waveguide by pre-stressing or pre-compressing the waveguide based on an expected thermal gradient, expected environmental conditions, or expected mechanical stresses when the eyewear display device is in use.
